(19) United States
(12) Patent Application Publication
(10) Pub. No.: US 2025/0139655 A1
(43) Pub. Date: May 1, 2025

(54) SYSTEM AND METHOD FOR AUTO-GENERATING QR CODES

(71) Applicant: Ferda, LLC, Lake Forest, IL (US)

(72) Inventors: Dimitrios Dean Svigos, Lake Forest, IL (US); Nikolas Grant Svigos, Lake Forest, IL (US); Tomas Mukulis, Vinius (LT)

(21) Appl. No.: 18/931,969

(22) Filed: Oct. 30, 2024

Related U.S. Application Data
(60) Provisional application No. 63/594,075, filed on Oct. 30, 2023.

(51) Int. Cl. G06Q 30/0214; G06Q 30/0207; G06Q 30/0238; G06Q 30/0251

(52) U.S. Cl. CPC G06Q 30/0214; G06Q 30/0238; G06Q 30/0239; G06Q 30/0253; G06Q 30/0267

(57) ABSTRACT

A method, computer program product, and computing system for obtaining a plurality of required information of a first customer to complete a purchase of a first product. A profile unique to the first customer may be generated using the required information of the first customer after completion of the purchase of the first product. A QR code may be generated automatically that links to the profile of the first customer. The QR code is applied to the first product, physically or digitally. The first customer may be incentivized for promoting the first product by causing a potential customer to scan the QR code of the first product and be directed to a web URL linked to the QR code.

### RELATED APPLICATIONS

This application claims benefit of U.S. Provisional Application No. 63/594,075, filed Oct. 30, 2023, the entire contents of which may be incorporated herein by reference.

### BACKGROUND

Current “affiliate marketing” programs use self-selecting “influencers” that share links and generic QR codes. Accordingly, various methodologies may be employed to earn money by pushing products that companies are trying to sell by bothering people to buy things.

### Summary of Disclosure

In one example implementation, a computer-implemented method is provided. The method may include obtaining a plurality of required information of a first customer to complete a purchase of a first product. A profile unique to the first customer may be automatically generated using the required information of the first customer after completion of the purchase of the first product. A QR code “quick-response code” may be generated automatically that links to the profile of the first customer. The QR code may be applied to the first product, physically or digitally. The first customer may be incentivized for promoting the first product by causing a potential customer to scan the QR code of the first product and be directed to a web URL (Uniform Resource Locator) linked to the QR code.

One or more of the following example features may be included. An order confirmation email may be received after the first product purchase. The order confirmation email includes at least a login information for the profile of the first customer. The first customer is able to share at least one of the web URL and the QR code within a network of the first customer. The QR code is unique to the first customer and is automatically applied onto the first product when produced. The first product may be delivered with the applied QR code to the first customer. The first customer incentivizing for promoting the first product by causing the potential customer to scan the QR code of the first product and be directed to the web URL linked to the QR code may include scanning the QR code on the first product of the first customer by the potential customer, directing the potential customer to the profile of the first customer to view and purchase at least one of the first product and a second product entirely different from the first product, and receiving an incentive by the first customer on the potential customer using the QR code of the first customer for purchasing the at least one of the first product and the second product.

In another example implementation a system is provided. The system may include at least one processor configured to obtain a plurality of required information of a first customer to complete a purchase of a first product and to generate a profile unique to the first customer using the required information of the first customer after completion of the purchase of the first product. The at least one processor may be further configured to generate automatically and simultaneously a QR code that links to the profile of the first customer, wherein the QR code is applied to the first product, physically or digitally. The at least one processor may be further configured to incentivize the first customer for promoting the first product by causing a potential customer to scan the QR code of the first product and be directed to a web URL linked to the QR code.

One or more of the following example features may be included. An order confirmation email may be received after the first product purchase. The order confirmation email includes at least a login information for the profile of the first customer. The first customer is able to share at least one of the web URL and the QR code within a network of the first customer. The QR code is unique to the first customer and is automatically applied onto the first product when produced. The first product may be delivered with the applied QR code to the first customer. The first customer incentivizing for promoting the first product by causing the potential customer to scan the QR code of the first product and be directed to the web URL linked to the QR code may include scanning the QR code on the first product of the first customer by the potential customer, directing the potential customer to the profile of the first customer to view and purchase at least one of the first product and a second product entirely different from the first product, and receiving an incentive by the first customer on the potential customer using the QR code of the first customer for purchasing the at least one of the first product and the second product.

In one example implementation, a computer-readable storage medium having stored thereon instructions, which when executed by a processor result in one or more operations is included. The operations may include obtaining a plurality of required information of a first customer to complete a purchase of a first product. A profile unique to the first customer may be generated using the required information of the first customer after completion of the purchase of the first product. A QR code “quick-response code” may be generated automatically and simultaneously that links to the profile of the first customer. The QR code may be applied to the first product, physically or digitally. The first customer may be incentivized for promoting the first product by causing a potential customer to scan the QR code of the first product and be directed to a web URL (Uniform Resource Locator) linked to the QR code.

One or more of the following example features may be included. An order confirmation email may be received after the first product purchase. The order confirmation email includes at least a login information for the profile of the first customer. The first customer is able to share at least one of the web URL and the QR code within a network of the first customer. The QR code is unique to the first customer and is automatically applied onto the first product when produced. The first product may be delivered with the applied QR code to the first customer. The first customer incentivizing for promoting the first product by causing the potential customer to scan the QR code of the first product and be directed to the web URL linked to the QR code may include scanning the QR code on the first product of the first customer by the potential customer, directing the potential customer to the profile of the first customer to view and purchase at least one of the first product and a second product entirely different from the first product, and receiving an incentive by the first customer on the potential customer using the QR code of the first customer for purchasing the at least one of the first product and the second product.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a QR code generation process coupled to an example distributed computing network according to one or more example implementations of the disclosure;

FIG. 2 is an example flowchart of the QR code generation process according to one or more example implementations of the disclosure;

FIG. 3 is an example flowchart of the QR code generation process according to one or more example implementations of the disclosure.

FIGS. 4a-4g are example flowcharts of the QR code generation process shown in FIG. 3 according to one or more example implementations of the disclosure.

Like reference symbols in the various drawings indicate like elements.

### DETAILED DESCRIPTION

### System Overview:

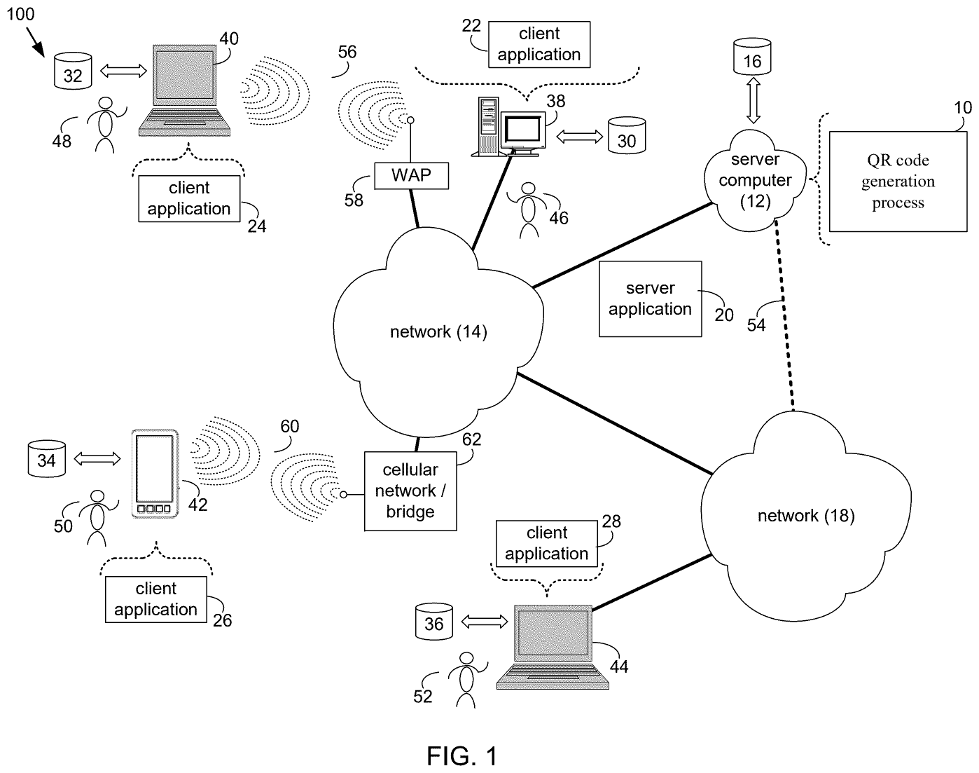

Referring to FIG. 1, there is shown a QR code generation process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both). Additionally and/or alternatively, the QR code generation process 10 may reside on a client electronic device, such as a personal computer, notebook computer, personal digital assistant, or the like.

The instruction sets and subroutines of the QR code generation process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of the QR code generation process 10 may be stored on storage devices (and/or executed by processors and memory architectures) that are external to storage device 16.

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Lotus Domino™ Server and Microsoft Exchange™ Server. Server application 20 may interact with one or more client applications (e.g., client applications 22, 24, 26, 28) in order to execute the QR code generation process 10. In some embodiments, the QR code generation process 10 may be stand-alone application that interface with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition/as an alternative to being server-based applications residing on server computer 12, the QR code generation process 10 may be client-side application residing on one or more client electronic devices 38, 40, 42, 44 (e.g., stored on storage devices 30, 32, 34, 36, respectively). As such, the QR code generation process 10 may be stand-alone application that interfaces with a client application (e.g., client applications 22, 24, 26, 28), or may be applets/applications that may be executed within a client application. As such, the QR code generation process 10 may be client-side processes, server-side processes, or hybrid client-side/server-side processes, which may be executed, in whole or in part, by server computer 12, or one or more of client electronic devices 38, 40, 42, 44.

Network 14 may be connected to one or more secondary networks (e.g., network 18), examples of which may include but are not limited to: a local area network; a wide area network; or an intranet, for example.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may utilize formal analysis, testbench simulation, and/or hybrid technology features to verify a particular integrated circuit design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, the QR code generation process 10 may be cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11 g, 802.11n, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system.

In some implementations, as will be discussed below in greater detail, the QR code generation process 10 of FIG. 1, may include but is not limited to, obtaining a plurality of required information of a first customer to complete a purchase of a first product. A profile unique to the first customer may be generated using the required information of the customer after completion of the purchase of the first product. A QR code may be generated automatically and simultaneously that links to the profile of the first customer. The QR code is applied to the first product, physically or digitally. The first customer may be incentivized for promoting the first product by causing a potential customer to scan the QR code of the first product and be directed to a web URL linked to the QR code.

For example, purposes only, server computer 12 may be described as being a network-based server computer that includes a plurality of electro-mechanical backend storage devices. However, this is for example purposes only and is not intended to be a limitation of this disclosure, as other configurations are possible and are considered to be within the scope of this disclosure.

### The QR Code Generation Process:

Embodiments included herein may use any suitable type of QR code. For example, some embodiments may utilize “regular” or “dynamic” either alone or in combination. It should be noted that any type of scannable code may be used without departing from the scope of the present disclosure. Some or all of the QR codes discussed herein may be printed and applied to various types of merchandise.

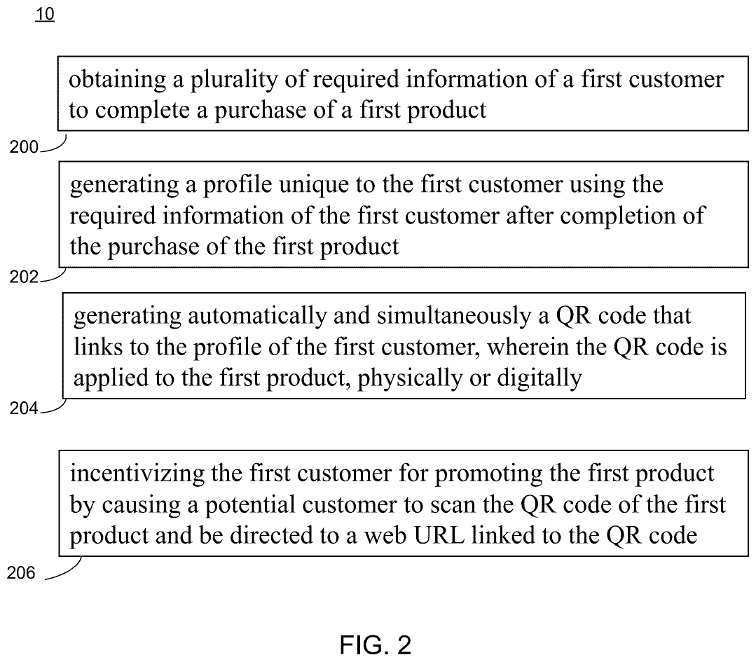

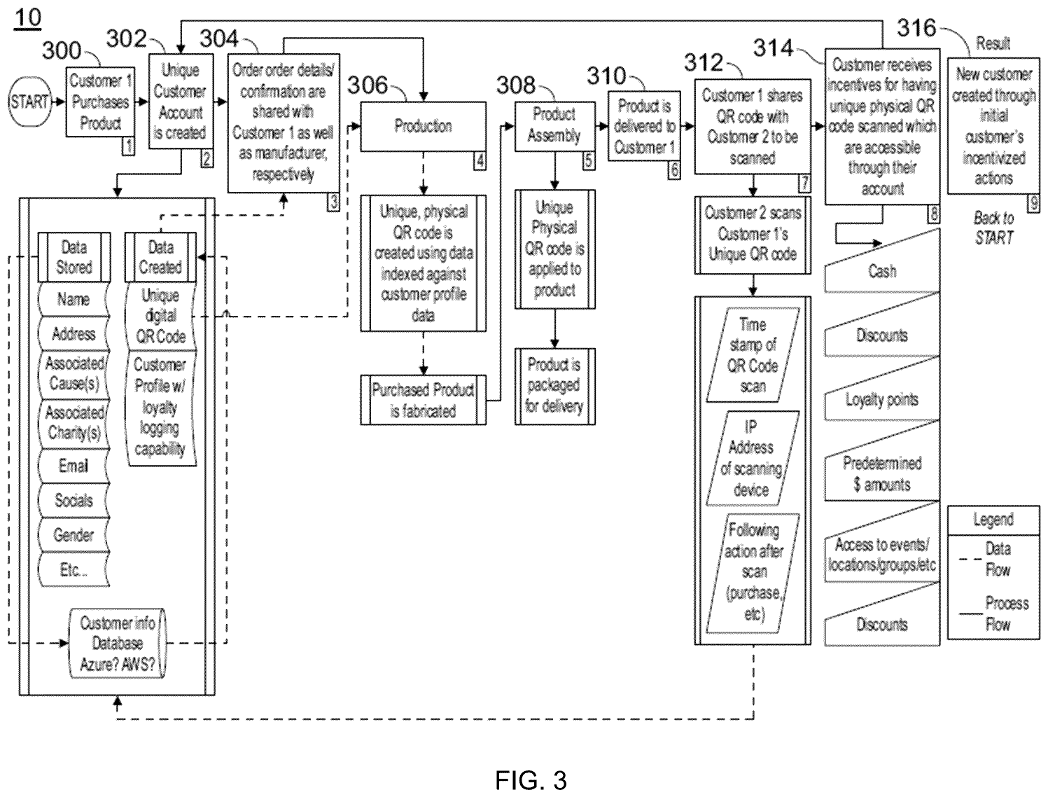

Referring also to FIGS. 2 and 3 and in some implementations, the QR code generation process 10 may obtain 200 a plurality of required information of a first customer to complete a purchase of a first product. A profile unique to the first customer may be generated 202 using the required information of the first customer after completion of the purchase of the first product. A unique digital QR code may be generated automatically and simultaneously 204 that links to the profile of the first customer. The QR code is applied to the first product, physically or digitally. The first customer may be incentivized 206 for promoting the first product by causing a potential customer to scan the QR code of the first product and be directed to a web URL linked to the QR code.

In some implementations, the QR code generation process 10 may enable physical and digital product manufacturers to harness the full potential of word-of-mouth marketing via the use of an auto-generating, QR code-based loyalty system. The QR code generation process 10 may automatically generate a unique QR code for any purchase which is then tied to a web-profile that is simultaneously and automatically generated for each unique customer when an E-commerce purchase is made. Unlike current “Affiliate Marketing” programs that allow “Affiliates” to earn money by pushing products that companies are trying to sell after a “self-selection” process in which they are required to actively decide that they want to become an “affiliate”, the process defined within one or more embodiments may differ as the QR code generation process 10 enables every customer to make money off of the products they were going to buy anyway in both the physical and digital world—removing multiple steps within the process and turning all products into their own promotional billboard.

As will be discussed in greater detail below, implementations of the present disclosure may leverage customers that are already interested in a product enough to buy it and then may use the product to market itself, unlike current “affiliate marketing” programs that use self-selecting “influencers” that share links and generic QR codes—there is no need to share links or bother people to buy things. In particular, the QR code and a customer loyalty profile may simultaneously and automatically generate at the point of purchase. In addition, the customer's unique QR code may be automatically applied onto the product that has been purchased such as physical apparel when produced and may be linked to the customer's unique webpage for the specific product they are using. With conventional approaches, the companies share generic QR codes on the products, for example, clothing that links to website homepages, event details pages.

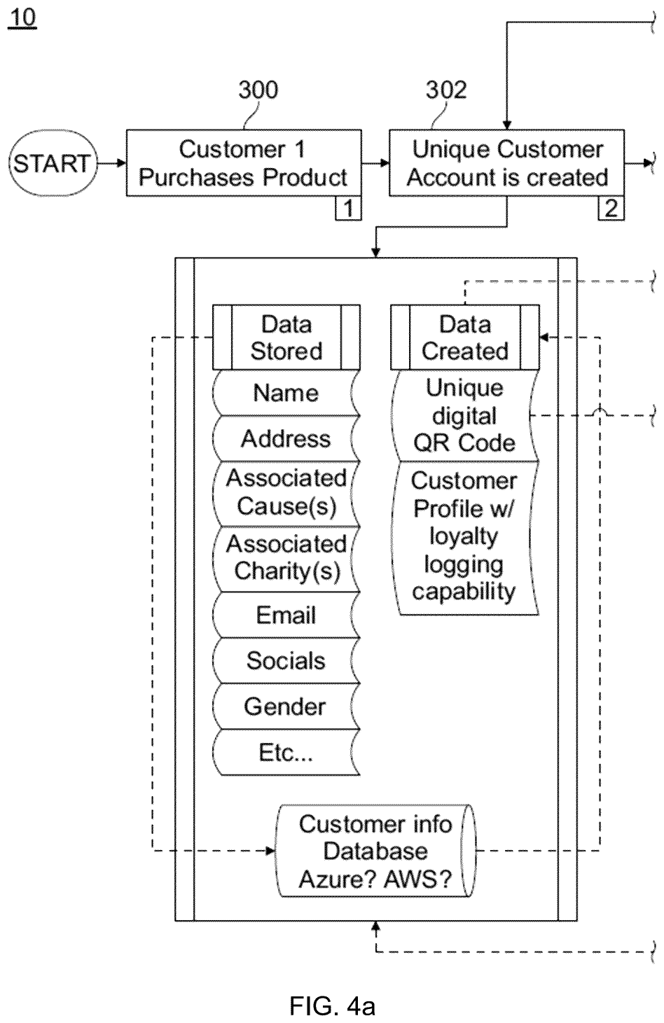

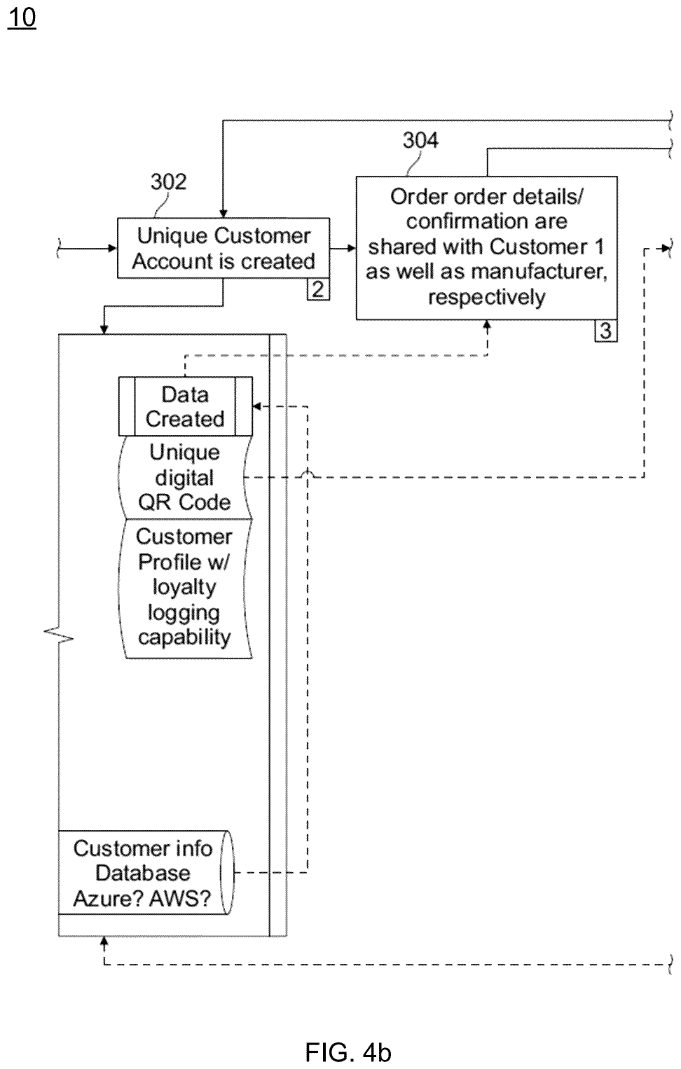

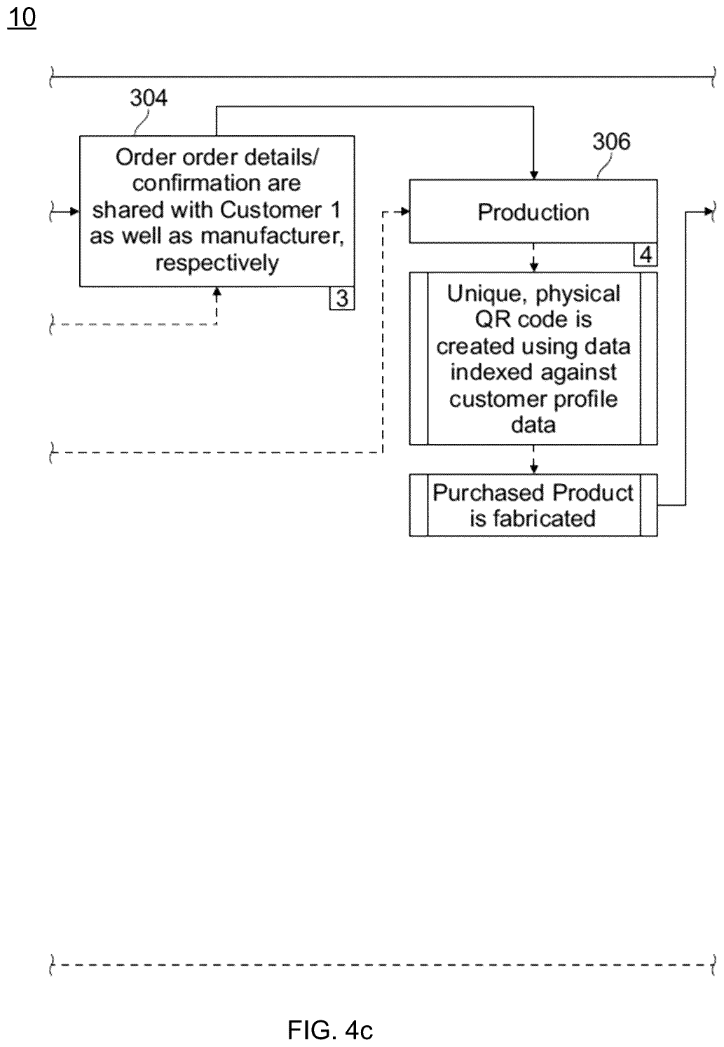

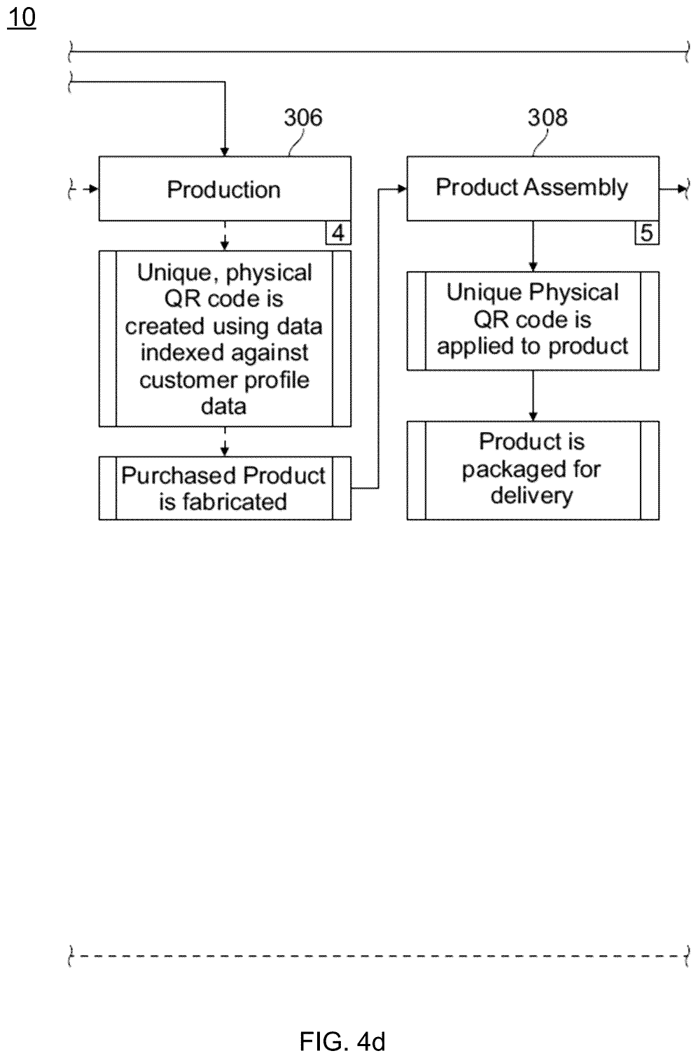

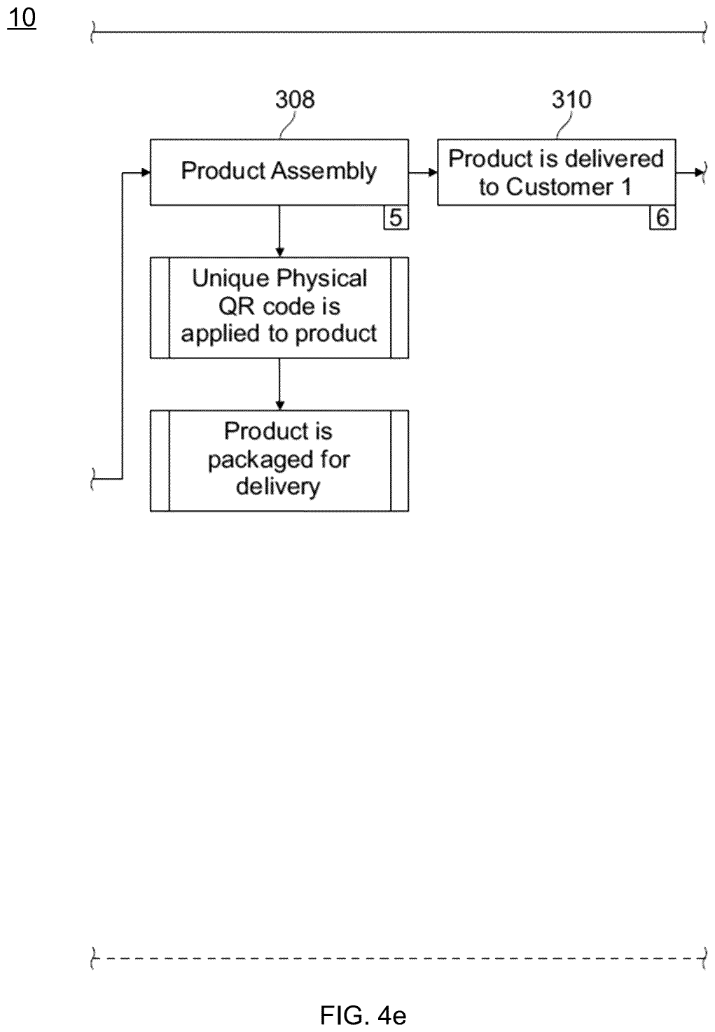

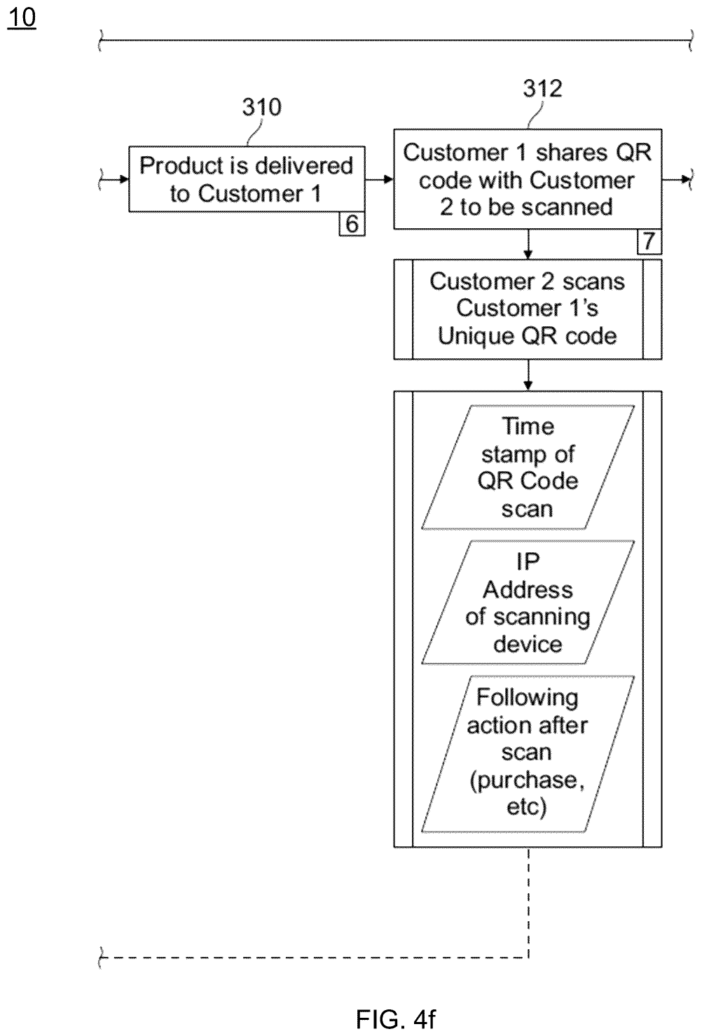

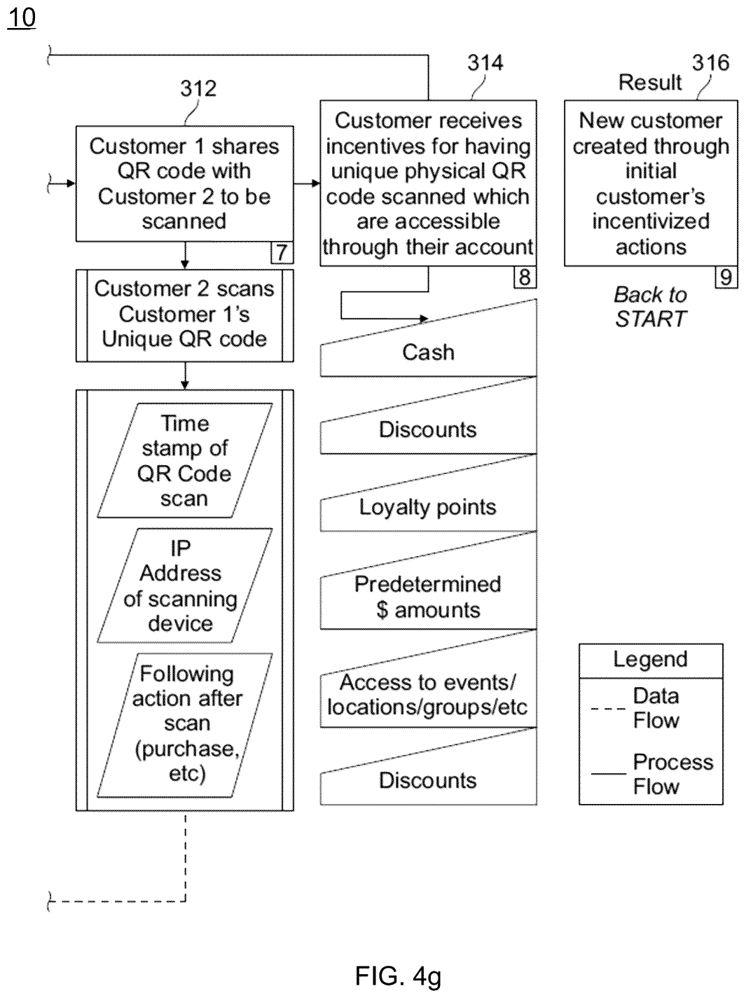

Referring also to FIGS. 3 and 4a and in some implementations, the QR code generation process 10 may obtain 200 a plurality of required information of a first customer to complete a purchase of a first product (e.g., customer purchase product 300). For example, a customer may need the ability to create a user profile so that the customer may log in and see his shopping cart that is filled with products he has not yet confirmed, previous orders, and other things that are typical of an ecommerce website. Assume that “Customer A” is buying a shirt. During the product purchase step, the Customer A purchases a product online. During the confirmation stage of the product purchase, the Customer A is prompted to enter required information to complete the purchase such as name, address, e-mail, social media profile info, gender, preferred payment method (e.g., PayPal, Venmo, and the like) with username/phone number to direct payment correctly, etc.

Referring also to FIGS. 3 and 4a and in some implementations, the QR code generation process 10 may generate profile unique to the first customer (e.g., unique customer account created 302) may be generated 202 using the required information of the first customer after completion of the purchase of the first product. For example, after the Customer A enters the required information and buys the product a unique Customer Loyalty Profile (The “Profile”) is created using the information that was required of them to disclose during the previous step. This URL is where other customers may direct toward when they scan the QR code. In some implementations, a user profile web page may be created, preferred by the user, when creating account, with the customer's username as the differentiating factor within the URL so that other potential customers may search for the webpage.

In some implementations, the QR code generation process 10 may generate automatically and simultaneously 204 a QR code that links to the profile of the first customer. The QR code is applied to the first product, physically or digitally. For example, when the profile is created, a QR code that links to the profile is simultaneously created and married to the product transaction via its digital signature/file. In some implementations, a customer may need the ability to show the products that the customer in question has purchased (without noting the size) so that others who visit the user profile webpage may view said products and purchase them by clicking on the products they see.

In some implementations, an e-commerce website may need the ability to collect and store customer order data in such a way that it may be filtered by the following data points so that the website admin may find order information with ease when needed: Some of this data may include, but is not limited to, first name, last name, order confirmation number, product item code, time of purchase (MM/DD/YYY/MM/SS/MSMS (Millisecond) (these may all be separate columns so that they may be filtered individually), preferred shipping address (able to store various addresses and denote which is “preferred” by clicking a check box), associated causes, E-mail, gender, social profiles (if supplied by customer), etc.

In some implementations, the e-commerce website may further need the ability to collect and store customer order data in such a way that it may be shared with manufacturers so that they understand what to produce for the customers who have made orders. Some of this data may include, but is not limited to, first name, last name, order confirmation number, product item code, preferred shipping address (able to store various addresses and denote which is “preferred” by clicking a check box), etc.

In some implementations, a website admin may schedule the sharing of order data with manufacturers so that this process is never forgotten, and the customers always have their orders produced in a timely manner. The website admin may need to be able to schedule the sharing of this data with a set of inputs on time zone (hourly, daily, weekly), for hourly (whole numbers only, i.e., “hourly, CST, 7:00 AM . . . 8:00 AM . . . 9:00 AM . . . etc.), for daily (set a single time at which the file is sent with ability to input hour, minute, AM/PM), for weekly (set a single day of the week (Mon/Tues/Wed/Thurs/Fri/Sat/Sun) and the time of day), etc.

Referring also to FIGS. 3 and 4b and in some implementations, the QR code generation process 10 may receive an order confirmation email after the first product purchase (e.g., order confirmation is received by consumer via email 304). The order confirmation email includes at least a login information for the profile of the first customer and the first customer is able to share at least one of the web URL and the QR code within a network of the first customer. For example, during the order confirmation/loyalty profile step, the Customer A receives an order confirmation email which includes, among other things, the login information for their newly created profile, they are able to share the web URL or the QR code with their network for a QR Code based loyalty system. In some implementations, the QR code is unique to the first customer and is automatically applied onto the first product when produced.

In some implementations, the QR Code based loyalty system may need the ability to log the Operating System (OS) of any device that is scanning the QR code so that the website admin may call on and view the scan based on OS.

Referring also to FIGS. 3, 4c, and 4d, during the production step (e.g. production 306), as any product that utilizes this business method is produced, the unique QR Code that was generated at the point of its purchase is to be applied to it, physically or digitally, so that it can be scanned by anyone to be directed to the URL it is linked to (e.g. product assembly 308). Some of the examples of the product where this business method is applicable includes apparel (clothing, shoes, etc.), sports apparel (balls, bats, etc.), physical product marketing, event promotion, political campaigns, and social networking. In some implementations, the website may need the ability to filter products according to few details so that the customer may find what he is looking for. Some of this detail may include, but is not limited to, associated cause, sex (M/F), clothing type (shirts, sweatshirts, etc.), color, cost (least to greatest, greatest to least), new arrivals (items listed in descending order from most recently to least recently added), design criteria (for example, vertical filters, flush to the left side of the screen as not to hinder the customer's view of the products), etc.

In some implementations, a product filter button from the website may need the ability to appear as a clickable button so that when a filter is clicked further option details drop down when, such that the content below that filter is moved further down the page to make room for the newly visible content. For example, the product filter button may need the ability to show a “+” symbol to the right of the filter description that turns into a “−” symbol when the filter is engaged. Further, the product filter button may need the ability to change back from a “−” symbol into a “+” symbol whenever a customer clicks on me a second time so that they understand the filer has been disengaged. The additional product selection options that dropped down when the filter was engaged by move up and disappear once again when the filter is disengaged.

Referring also to FIGS. 3 and 4e and in some implementations, the QR code generation process 10 may deliver the first product with the applied QR code to the first customer (e.g., product is delivered to customer 310). For example, after the product is delivered, the Customer A may now receive the product with the unique QR code applied. In some implementations, the e-commerce website may need the ability to take payment in the form of Credit Card, Debit Cards, PayPal, Venmo, CashApp, Zelle, Apple Pay so that the customers may pay for products that they want to purchase. In some implementations, a billing system may need the ability to send payment to any customer whose unique QR code is responsible for another customer's purchase so that the incentive function of the QR Code based Loyalty System is honored. For example, for the billing, the website admin may need the ability to define the description of the payment “subject” line within any payment platform so that the customer may read and understand the line item within their credits/debits is from #Ferda. As an example, “#Ferda Loyalty Incentive for sale of product via QR Code.”

In some implementations, for an order confirmation feature, the website admin may need the ability to be prompted with an order confirmation page before confirming that the customer wants to place the order so that the customer may confirm some details and/or edit the quantity/size/color of any products within the basket which should be shown on the screen in a pleasant manner. Some of these details may include, but is not limited to, photos of the products in the basket, quantity of each unique product within the basket, total cost (Quantity×Unit cost) for unique products in the basket, shipping cost, taxes, total cost of all items within the basket with shipping and taxes. The payment providers may offer FREE shipping, for example, for start.

In some implementations, the website may need the ability to use #Ferda branding guidelines throughout the design of the website, for example, the website admin may need the ability to present information, actionable icons, and photos/videos so that the #Ferda Brand is imprinted onto the customer in a visually appealing way.

In some implementations, the QR code generation process 10 may incentivize 206 the first customer for promoting the first product by causing a potential customer to scan the QR code of the first product and be directed to a web URL linked to the QR code. For example, as the Customer A wears or uses this physical product around others, the Customer A may incentivize to promote the product which may then, in turn, cause potential customers to scan the QR code. Even if the Customer A does not promote the product though, potential customers who like the product are able to scan the QR code. In some implementations, an inventory management system may need the ability to tie the unique QR code that is created for each product/order to the product/order itself so that when the customer orders a product, the QR code maybe linked to the product order so that the apparel manufacturer may know which QR code to print and apply to which order.

Referring also to FIGS. 3 and 4f and in some implementations, the QR code generation process 10 may scan the QR code on the first product of the first customer by the potential customer. For example, a potential Customer B scans the QR code on the Customer A's product (e.g., customer shares QR code with their social contacts to be scanned 312).

In some implementations, the QR code generation process 10 may direct the potential customer to the profile of the first customer to view and purchase at least one of the first product and a second product entirely different from the first product. For example, the potential Customer B may be directed to the Customer A's profile, where the potential customer B is able to view and purchase the product in question.

Referring also to FIGS. 3 and 4g and in some implementations, the QR code-based loyalty system may need the ability to automatically create the unique QR code any time the customer purchases a product (after payment is submitted and verified). The QR code may be linked to the webpage of the QR-code bearing customer's profile and the unique product that was generated for so that when the QR code is scanned by the potential customer that potential customer is directed to the original customer's user profile in order to be able to purchase the product (e.g. customer receives incentives for having unique physical QR code scanned which are accessible through their account 314). In addition, in some implementations, the QR code-based loyalty system may need the ability to log and sum the number of scans that each unique QR code receives so that the website admin may view said data at a later date using a format that may be shared or downloaded (excel, preferably).

In some implementations, the QR code-based loyalty system may need the ability to log the location from which any unique QR code is scanned so that the website admin may filter and view the geo data of scans based on continent, country, state, city, and zip code as well as longitude and latitude. In some implementations, the QR code-based loyalty system may need the ability to log the IP address of any mobile device that is used to scan the QR code so that the IP address can then be referenced if and when that same IP address is connected with the purchase of any product.

Referring also to FIGS. 3 and 4g and in and in some implementations, the QR code generation process 10 may receive an incentive by the first customer on the potential customer using the QR code of the first customer for purchasing the at least one of the first product and the second product (e.g. customer receives incentives for having unique physical QR code scanned which are accessible through their account 314). For example, the potential Customer B may purchase the same product as the Customer A or a different product entirely, as long as the first step in the customer journey involved the Customer A's QR code, the Customer A may receive incentive for the purchase—be it a set number of dollars, a percentage of sales, or loyalty points (e.g. new customers created through initial customer's incentivized actions 316). In addition, in some implementations, the QR code based loyalty system may need the ability to allow for the website admin to define (and switch between) a form of incentive for the customers to receive any time that the potential customer scans the customer's unique QR code and then purchases a product so that the customer to which the QR code belongs is motivated to sell more products.

In some implementations, the user profile may need the ability to allow the customers to choose which payment method they prefer to receive payment on whenever their QR code is scanned by another customer and the other customer then purchases a product so that the customers whom the QR code is tied to may be paid whenever their unique QR code results in the purchase of a product by another customer scanning it. Some of the payment methods may include, but is not limited to, PayPal, Apple Pay, etc.

In some implementations, the QR code generation process 10 may provide following advantages over other current/anticipated technologies:
1. Immediate leveraging of the customers as sales/marketing assets without the need for the self-selection that is currently required for “affiliate marketing” strategies.
2. The customers who purchase the products onto which the QR codes are applied are already self-selected as “fans,” the incentive to promote the product is secondary which—in turn—brings to bare a more authentic promotional message.
3. Streamlined and direct incentivization.
4. This process is “passive” as opposed to “active” for the customer.

In some embodiments, after the potential customer makes a purchase the purchase data may be stored within a data set and indexed against the first customer's personal data which may already be stored from when they made their initial purchase. This data may be stored in such a way that enables the backend system to recognize the purchase by the potential customer and then deliver an inventive to the first customer for the successful sale of a product.

In one example implementation, a computer-implemented method executed on a computing device may include, but is not limited to, obtaining a plurality of required information of a first customer to complete a purchase of a first product. A profile unique to the first customer may be generated using the required information of the first customer after completion of the purchase of the first product. A QR code “quick-response code” may be generated automatically and simultaneously that links to the profile of the first customer. The QR code is applied to the first product, physically or digitally. The first customer may be incentivized for promoting the first product by causing a potential customer to scan the QR code of the first product and be directed to a web URL (e.g., directed to the aforementioned unique URL web address/profile that was automatically created at the time the first customer purchased the first product) linked to the QR code. The first customer may be prompted to create a username and password during the purchase product so that they may gain access to the profile that is automatically created for them. The creation of a username and password may not be required for the purchase to be completed but the creation of a username and/profile enables the customer to login to their secure profile in order to review and/or change their affiliate details including but not limited to name, physical address, paypal account info, bank account #, bank routing #, and/pr delivery address, etc.

In some embodiments, the QR code may be automatically applied to the physical product regardless of whether or not the customer confirms their affiliate status by creating a username or login. Accordingly, the first customer may be provided with the ability to confirm their affiliate status by creating a username and password, which enables them to view and make changes to their unique profile, however it is not required. In this way, embodiments included herein provide for a passive nature of affiliate profile creation.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++, or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods, and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
obtaining a plurality of required information of a first customer to complete a purchase of a first product;
generating automatically a profile unique to the first customer using the required information of the first customer after completion of the purchase of the first product;
generating automatically a QR code that links to the profile of the first customer, wherein the QR code is applied to the first product, physically or digitally; and
incentivizing the first customer for promoting the first product by causing a potential customer to scan the QR code of the first product and be directed to a web URL linked to the QR code.

2. The computer-implemented method of claim 1, further comprising:
receiving an order confirmation email after the first product purchase, wherein the order confirmation email includes at least a login information for the profile of the first customer and wherein the first customer is able to share at least one of the web URL and the QR code within a network of the first customer.

3. The computer-implemented method of claim 1, wherein the QR code is unique to the first customer and is automatically applied onto the first product when produced.

4. The computer-implemented method of claim 1, further comprising delivering the first product with the applied QR code to the first customer.

5. The computer-implemented method of claim 1, wherein incentivizing the first customer for promoting the first product by causing the potential customer to scan the QR code of the first product and be directed to the web URL linked to the QR code includes:
scanning the QR code on the first product of the first customer by the potential customer.

6. The computer-implemented method of claim 5, wherein incentivizing the first customer for promoting the first product by causing the potential customer to scan the QR code of the first product and be directed to the web URL linked to the QR code includes:
directing the potential customer to the profile of the first customer to view and purchase at least one of the first product or a second product entirely different from the first product.

7. The computer-implemented method of claim 6, wherein incentivizing the first customer for promoting the first product by causing the potential customer to scan the QR code of the first product and be directed to the web URL linked to the QR code includes:
receiving an incentive by the first customer on the potential customer using the QR code of the first customer.

8. A system, comprising:
at least one processor configured to:
obtain a plurality of required information of a first customer to complete a purchase of a first product;
generate a profile unique to the first customer using the required information of the first customer after completion of the purchase of the first product;
generate automatically and simultaneously a QR code that links to the profile of the first customer, wherein the QR code is applied to the first product, physically or digitally; and
incentivize the first customer for promoting the first product by causing a potential customer to scan the QR code of the first product and be directed to a web URL linked to the QR code.

9. The system of claim 8, further comprising:
receiving an order confirmation email after the first product purchase, wherein the order confirmation email includes at least a login information for the profile of the first customer and wherein the first customer is able to share at least one of the web URL and the QR code within a network of the first customer.

10. The system of claim 8, wherein the QR code is unique to the first customer and is automatically applied onto the first product when produced.

11. The system of claim 8, further comprising delivering the first product with the applied QR code to the first customer.

12. The system of claim 8, wherein incentivizing the first customer for promoting the first product by causing the potential customer to scan the QR code of the first product and be directed to the web URL linked to the QR code includes:
scanning the QR code on the first product of the first customer by the potential customer.

13. The system of claim 12, wherein incentivizing the first customer for promoting the first product by causing the potential customer to scan the QR code of the first product and be directed to the web URL linked to the QR code includes:
directing the potential customer to the profile of the first customer to view and purchase at least one of the first product or a second product entirely different from the first product.

14. The system of claim 13, wherein incentivizing the first customer for promoting the first product by causing the potential customer to scan the QR code of the first product and be directed to the web URL linked to the QR code includes:
receiving an incentive by the first customer on the potential customer using the QR code of the first customer.

15. A computer-readable storage medium having stored thereon instructions, which when executed by a processor result in one or more operations, the operations comprising:
obtaining a plurality of required information of a first customer to complete a purchase of a first product;
generating a profile unique to the first customer using the required information of the first customer after completion of the purchase of the first product;
generating automatically and simultaneously a QR code that links to the profile of the first customer, wherein the QR code is applied to the first product, physically or digitally; and
incentivizing the first customer for promoting the first product by causing a potential customer to scan the QR code of the first product and be directed to a web URL linked to the QR code.

16. The computer-readable storage medium of claim 15, further comprising:
receiving an order confirmation email after the first product purchase, wherein the order confirmation email includes at least a login information for the profile of the first customer and wherein the first customer is able to share at least one of the web URL and the QR code within a network of the first customer.

17. The computer-readable storage medium of claim 15, wherein the QR code is unique to the first customer and is automatically applied onto the first product when produced.

18. The computer-readable storage medium of claim 15, further comprising delivering the first product with the applied QR code to the first customer.

19. The computer-readable storage medium of claim 15, wherein incentivizing the first customer for promoting the first product by causing the potential customer to scan the QR code of the first product and be directed to the web URL linked to the QR code includes:
scanning the QR code on the first product of the first customer by the potential customer.

20. The computer-readable storage medium of claim 19, wherein incentivizing the first customer for promoting the first product by causing the potential customer to scan the QR code of the first product and be directed to the web URL linked to the QR code includes:
directing the potential customer to the profile of the first customer to view and purchase at least one of the first product or a second product entirely different from the first product.
